(19) United States
(12) Patent Application Publication
(10) Pub. No.: US 2014/0147543 A1
(43) Pub. Date: May 29, 2014

(54) FLUID PRESSURE IMPRINTING DEVICE PROVIDED WITH PRESSURIZATION UNIT SECURING TOOL

(71) Applicants: Hirosuke Kawaguchi, Tokyo (JP); Hironobu Tamura, Kanagawa (JP); Satoru Tanaka, Tokyo (JP)

(72) Inventors: Hirosuke Kawaguchi, Tokyo (JP); Hironobu Tamura, Kanagawa (JP); Satoru Tanaka, Tokyo (JP)

(73) Assignee: SCIVAX CORPORATION, Kanagawa (JP)

(21) Appl. No.: 14/232,081

(22) PCT Filed: Jul. 6, 2012
(86) PCT No.: PCT/JP2012/067386

§ 371 Date: Feb. 3, 2014

(30) Foreign Application Priority Data
Jul. 11, 2011 (JP) 2011-153019

(51) Int. Cl. B29C 59/02

(52) U.S. Cl. CPC B29C 59/02
USPC 425/385

(57) ABSTRACT

An imprinting device is provided which is capable of using small an opening/closing device even when a transfer area increases. The imprinting device that transfers a molding pattern of a die to a molding target includes a pressurization unit that includes a pressurization chamber to pressurize the die and the molding target by a fluid, a stage that supports the die and the molding target pressurized by the pressurization unit, a pressurization device for adjusting the pressure of the fluid inside the pressurization chamber, an opening/closing device for relatively moving the pressurization unit and the stage, and a securing tool that secures the pressurization unit and the stage so as to prevent or suppress an application of force generated by the pressurization unit to the opening/closing device.

### TECHNICAL FIELD

The present invention relates to an imprinting device provided with a securing tool for securing a pressurization unit.

### BACKGROUND ART

In recent years, nano-imprinting techniques are getting attention as a method of forming an ultra micropattern in a micro order or a nano order. This is to pressurize a die having a micropattern against a molding target, such as a resin, and to transfer the pattern to the molding target through heat or light (see, for example, Patent Literature 1). In such imprinting techniques, an imprinting device utilizing a fluid pressure is considered in order to increase a transfer area (see, for example, Patent Literature 2).

Patent Literature 1: WO2004/062886

Patent Literature 2: JP 2009-154393 A

### SUMMARY OF INVENTION

### Technical Problem

As illustrated in FIG. 7, a conventional imprinting device includes a pressurization chamber casing 52 that forms a pressurization chamber 51 together with a molding target 200 (or a die 100), sealing means 54 for sealing a space with the molding target 200 (or the die 100), and opening/closing means 8 for opening or closing a space between the pressurization chamber casing 52 and the molding target 200 (or the die 100). In such a configuration, however, since a pressurization unit 5 and a stage 2 are closed only by the opening/closing means 8, it is necessary for the opening/closing means 8 to support the whole force generated upon pressurization. Hence, there is a problem in which the larger the transfer area becomes, the more the size and the cost of the opening/closing means 8 increase.

Therefore, it is an object of the present invention to provide an imprinting device capable of using small opening/closing means even when a transfer area increases.

### Solution to Problem

In order to accomplish the above-described object, there is provided an imprinting device that transfers a molding pattern of a die to a molding target, the imprinting device including: a pressurization unit that includes a pressurization chamber to pressurize the die and the molding target by a fluid; a stage that supports the die and the molding target pressurized by the pressurization unit; pressurization means for adjusting the pressure of the fluid inside the pressurization chamber; opening/closing means for relatively moving the pressurization unit and the stage; and a securing tool that secures the pressurization unit and the stage so as to suppress an application of force generated in the pressurization unit to the opening/closing means.

In this case, it is preferable that the securing tool include a first securing tool and a second securing tool that are movable relative to each other. More specifically, the first securing tool is disposed with a space that allows the pressurization unit and the stage to move relative to each other, and the second securing tool is formed so as to be movable to the space at a position where the pressurization unit pressurizes the die and the molding target.

Moreover, it is preferable that the imprinting device include securing tool moving means for relatively moving the first securing tool and the second securing tool. For example, the securing tool moving means applicable moves upon relative rotation of the first securing tool and the second securing tool.

Furthermore, it is preferable that the securing tool receive a force generated by the pressurization unit in a distributed manner.

Still further, the pressurization unit may include a pressurization chamber casing that forms the pressurization chamber together with the die or the molding target, and sealing means for sealing a space with the die or the molding target, and, the opening/closing means may open and close the space between the pressurization chamber casing and the die or the molding target. Yet further, as another example applicable pressurization unit, the pressurization unit may include a flexible film that is disposed on a surface contacting the die or the molding target, and a pressurization chamber casing that forms the pressurization chamber together with the film.

### ADVANTAGEOUS EFFECTS OF INVENTION

According to the imprinting device of the present invention, since the securing tool that secures the pressurization unit and the stage is used in order to suppress an application of the force generated in the pressurization unit to the opening/closing means, it becomes possible to use the small opening/closing means even when a transfer area increases, and the cost of the imprinting device can be reduced.

### BRIEF DESCRIPTION OF DRAWINGS

FIG. 1 is a front view illustrating an imprinting device according to the present invention in a secured state;

FIG. 2 is a front view illustrating the imprinting device according to the present invention in a released state;

FIG. 3 is a front view illustrating the imprinting device according to the present invention when a pressurization unit is released;

FIG. 4 is a plan view taken along an arrow direction I-I in FIG. 1;

FIG. 5 is a plan view taken along an arrow direction II-II in FIG. 2;

FIG. 6 is a schematic cross-sectional view illustrating a structure of the pressurization unit; and

FIG. 7 is a front view illustrating a conventional imprinting device.

### DESCRIPTION OF EMBODIMENTS

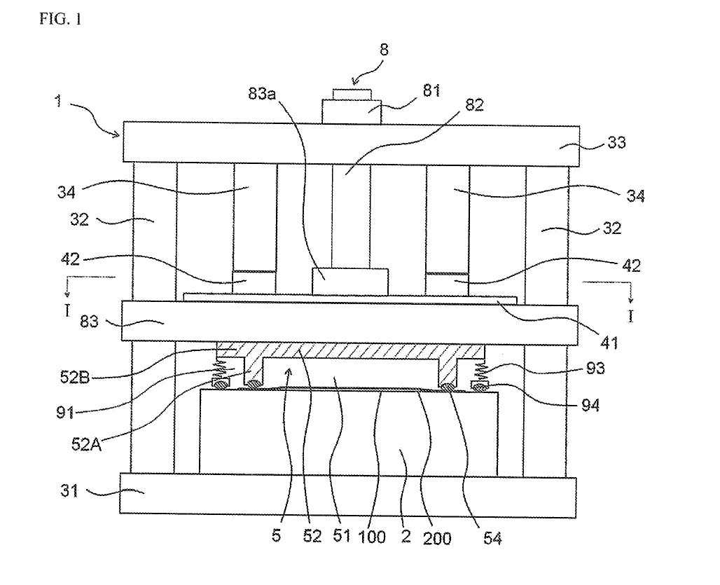

As illustrated in FIGS. 1 to 6, an imprinting device of the present invention is to transfer a molding pattern of a die 100 to a molding target 200, and mainly includes a pressurization unit 5 with a pressurization chamber 51 to pressurize the die 100 and the molding target 200 with a fluid, a stage 2 that supports the die 100 and the molding target 200 to which pressure by the pressurization unit 5 are applied, pressurization means 6 for adjusting the fluid pressure inside the pressurization chamber 51, opening/closing means 8 for relatively moving the pressurization unit 5 and the stage 2, and a securing tool 1 that secures the pressurization unit 5 and the stage 2 so as to avoid or suppress an application of force generated by the pressurization unit 5 to the opening/closing means 8.

Note that in the present specification, the die 100 indicates, e.g., a die that is formed of “metal like nickel”, “ceramics”, “carbon like glass-like carbon”, “silicon”, or the like, and has one end surface (molding surface) formed with a predetermined pattern. This pattern can be formed by performing a precise machining process on the molding surface. Moreover, the pattern may be formed through a semiconductor microfabrication technique like etching performed on a silicon substrate or the like. Still further, the pattern may be formed by performing metal plating on the surface of the silicon substrate or the like through an electroforming method, e.g., a nickel plating method and by peeling off the metal plating layer. In addition, a resin-made die that is formed through an imprinting technique is applicable. In this case, the die may be formed in a film shape that is flexible with respect to the molding target surface of the molding target 200. Needless to say, the material of the die 100 and the manufacturing method thereof are not limited to particular ones as long as a micropattern can be formed.

Moreover, the molding pattern that is formed on the die 100 includes not only a geometric shape with unevenness but also, e.g., a shape that transfers a predetermined surface condition like a mirror surface condition having a predetermined surface roughness, or a shape that transfers an optical element like a lens having a predetermined curvature. Still further, the molding pattern is formed in various sizes in which the minimum dimensions of a width of a convex portion and a width of a concave portion in a planar direction are equal to or smaller than 100 μm, equal to or smaller than 10 μm, equal to or smaller than 2 μm, equal to or smaller than 1 μm, equal to or smaller than 100 nm, and equal to or smaller than 10 nm. Moreover, the molding pattern is also formed in various sizes in which the dimension in the depth direction is equal to or greater than 10 nm, equal to or greater than 100 nm, equal to or greater than 200 nm, equal to or greater than 500 nm, equal to or greater than 1 μm, equal to or greater than 10 μm, and equal to or greater than 100 μm.

Still further, the molding target 200 indicates, e.g., a thermoplastic resin, a photo-curable resin, or a thermosetting resin.

Example thermoplastic resins applicable are a cyclic-olefin-based resin, such as a cyclic olefin ring-opening polymer/hydrogenated substance (COP) or a cyclic olefin copolymer (COC), an acrylic resin, polycarbonate, a vinyl-ether resin, a fluorine-based resin, such as perfluoroalkoxyalkane (PFA) or polytetrafluoroethylene (PTFE), polystyrene, a polyimide-based resin, and a polyester-based resin.

Example photo-curable resins or the thermosetting resins applicable are unsaturated hydrocarbon group containing compounds with vinyl group or allylic group, such as epoxide-containing compounds, (meta)acrylic ester compounds, vinyl-ether compounds, and bisallylnadimide compounds. In this case, polymerization-reactive-group containing compounds can be solely used for a thermal polymerization, or a thermal reactive initiator can be added to improve the thermosetting property. In addition, the molding target may be one that can form a molding pattern by letting a polymerization reaction progressed through an irradiation with light upon addition of a photoreactive initiator. Example thermal reactive radical initiators suitably applicable are organic peroxide and an azo compound. In this case, example photoreactive radical initiators suitably applicable are an acetophenone derivative, a benzophenone derivative, a benzoin ether derivative, and a xanthone derivative. Still further, a reactive monomer may be used without a solvent or may be used in a manner being dissolved in a solvent and being desolvated after being applied.

Furthermore, the molding target 200 may be formed in a flexible film shape or may be formed as a layer on a substrate that is formed of an inorganic compound like silicon, or metal.

Still further, the die 100 is disposed on the stage 2 and the molding target 200 is disposed on the pressurization unit 5 in FIGS. 1 to 3. However, the molding target 200 may be disposed on the stage 2 and the die 100 may be disposed on the pressurization unit 5.

The pressurization unit 5 includes the pressurization chamber 51 that directly or indirectly pressurizes the die 100 and the molding target 200 by a fluid. For example, the pressurization unit includes a pressurization chamber casing 52 that forms the pressurization chamber 51 with the molding target 200 (or the die 100), and sealing means 54 for sealing a space with the molding target 200 (or the die 100). FIG. 1 illustrates a case in which the pressurization chamber 51 is formed by the pressurization chamber casing 52 and the molding target 200.

The pressurization chamber casing 52 is formed as a cylinder with an opening and a bottom, and forms the pressurization chamber 51 as a sealed space by closing the opening with the molding target 200 (or the die 100). The opening is formed so as to be at least larger than the pattern area transferred to the molding target 200. The material is not limited to any particular one as long as it has pressure resistance and thermal resistance characteristics with respect to the molding condition during imprinting. For example, metal like stainless steel is applicable.

The sealing means 54 causes the pressurization chamber casing 52 and the molding target 200 (or the die 100) to intimately contact with each other in order to seal the pressurization chamber 51. For example, as illustrated in FIG. 1, an O-ring is prepared as the sealing means 54, recessed groove (unillustrated) shallower than the diameter of the cross-section of the O-ring is formed in a stage-side end of a side wall 52A of the pressurization chamber casing 52, and the O-ring is disposed in this groove. Accordingly, since the molding target 200 (or the die 100) is held between the pressurization chamber casing 52 and the stage 2, and the pressurization chamber casing 52 comes into intimately contact with the molding target 200, the interior of the pressurization chamber 51 can be sealed. In addition, even if the pressurization chamber casing 52 and the molding target 200 (or the die 100) are tilted relative to each other, the pressurization chamber 51 can be surely sealed if the parallelism is within the crush margin of the O-ring.

When the pressurization unit 5 is formed in this manner, it is desirable to use the molding target 200 (or the die 100) forming the pressurization chamber 51 that is formed in a flexible film-shape since such a molding target enables the fluid to apply uniform pressure to the molding target surface.

Still further, although it is not illustrated in the figure, as another example pressurization unit 5, the pressurization unit may be formed of a flexible film that is disposed on a surface contacting the molding target 200 (or the die 100), and a pressurization chamber casing that forms a pressurization chamber together with the film.

Example materials of the flexible film are a resin, thin metal, and an elastic member like rubber. In addition, when the pressurization chamber is provided with a light source that emits light with a predetermined wavelength to the molding target 200, a light permeable material is selected for the film. The film is formed so as to have a thickness of equal to or smaller than 10 mm, preferably, equal to or smaller than 3 mm, and more preferably, equal to or smaller than 1 mm.

Like the above-described example, the pressurization chamber casing is formed as a cylinder with an opening and a bottom. Moreover, the pressurization chamber casing and the film are firmly secured by an adhesive or the like, thereby sealing the interior of the pressurization chamber. Furthermore, the pressurization chamber casing and the film may be sealed by sealing means like an O-ring as described above.

The stage 2 is to support the die 100 and the molding target 200 both pressurized by the pressurization unit 5. The surface of the stage 2 contacting the die 100 (or the molding target 200) is formed in a desired shape that is sufficiently wide and smooth. The material is not limited to any particular one as long as it has pressure resistance and thermal resistance characteristics with respect to the molding condition during imprinting. For example, a ferrous material like carbon steel or metal like SUS is applicable. Moreover, when the molding target 200 (or the die 100) is heated from the stage-2 side, it is desirable to use a material like metal having a high thermal conductivity. Still further, when the molding target 200 (or the die 100) is heated from the pressurization-chamber-51 side, a material having a low thermal conductivity may be used in order to prevent heat from spreading to the stage 2. However, it is desirable to form the stage surface by a material having a high thermal conductivity in order to suppress a heating unevenness. Furthermore, when the light source is disposed at the stage-2 side during a photo imprinting process, it is fine if a transparent material like a glass is used. Yet further, in order to suppress a cause of an unnecessary transfer impress on the molding target 200, the die 100 and the stage 2 may be integrally formed together. For example, in the conventional technology, a pattern is formed by electroforming, and only a pattern portion is cut out for use. However, the pattern portion may be directly used without being cut out.

The pressurization means 6 is not limited to any particular one as long as it can adjust the pressure of the fluid inside the pressurization chamber 51 up to the pressure that enables a transfer of the pattern of the die 100 to the molding target 200. For example, as illustrated in FIG. 6, a pressurization chamber gas inlet/outlet passage 62 may be connected to the pressurization chamber casing 52, and a gas, such as air or an inert gas, may be fed to or discharged from the pressurization chamber 51 through the pressurization chamber gas inlet/outlet passage 62. For the supply of the gas, a gas supply source 61, such as a compressor or a tank having compressed gas therein is applicable. Further, for the discharge of the gas, it is not illustrated in the figure but a degassing valve may be opened or closed so as to discharge the gas. Note that a safety valve may be installed as needed.

The opening/closing means 8 is to relatively move the pressurization unit 5 and the stage 2. For example, the opening/closing means opens or closes the pressurization chamber 51 by causing the pressurization chamber casing 52 and the molding target 200 (or the die 100) to move close to each other or to move away from each other, and the opening/closing means is applicable which moves the pressurization chamber casing 52 by a hydraulic or pneumatic cylinder, or by an electric motor and a ball screw. In FIGS. 1 to 3, a movable plate 83 to which the pressurization unit 5 is secured is moved by an electric motor 81 and a ball screw 82 provided on a ceiling plate 33.

The securing tool 1 is to secure the pressurization unit 5 and the stage 2 to prevent or suppress an application of force generated by the fluid inside the pressurization chamber 51 to the opening/closing means 8. For example, a first securing tool and a second securing tool that are movable relative to each other may be provided, the first securing tool may be disposed with a space for allowing the pressurization unit 5 and the stage 2 to move relatively, and the second securing tool may be formed so as to be movable to the space at a position where the pressurization unit 5 pressurizes the die 100 and the molding target 200. Moreover, when the transfer area increases, force that is generated by the pressurization unit 5 increases. Hence, when such force is received only by the center of the pressurization chamber casing 52 or the end thereof, the pressurization chamber casing 52 is distorted. Accordingly, it is desirable to devise the number of the securing tools 1 or the shape thereof so as to receive the force generated by the pressurization unit 5 in a distributed manner. In particularly, it is desirable that moment generated at the securing tool or the pressurization unit be decreased by the force generated by the pressurization unit 5.

More specifically, as illustrated in FIGS. 1 to 5, the first securing tool is formed by a base 31 on which the stage 2 is mounted, a plurality of first support pillars 32 that are disposed in the vertical direction from the base 31, a ceiling 33 that is supported by the first support pillars 32, and a plurality of second support pillars 34 that extend downwardly from the ceiling plate 33. Moreover, the second securing tool is formed by a rotation plate 41 that is rotatably provided on the movable plate 83 to which the pressurization unit 5 is secured, and third support pillars 42 that are secured onto the rotation plate 41.

The rotation plate 41 is not limited to any particular one as long as it can move the third support pillars 42. For example, the rotation plate has a circular hole 41a formed in the center thereof so as to be engaged with with a circular convex portion 83a provided on the movable plate 83. In addition, the rotation plate 41 or the movable plate 83 is provided with an air bearing (unillustrated) that can lift up the rotation plate 41 over the movable plate 83 by the pressure of gas. Accordingly, since the rotation plate 41 can rotate around the rotation axis including the hole and the convex portion, the space for securing the pressurization unit 5 and the stage 2 can be reduced.

The third support pillars 42 are formed so as to be slightly shorter than the height of the space that is formed between the lower surface of the second support pillar 34 and the upper surface of the rotation plate 41 when the pressurization chamber 51 is closed. Accordingly, the third support pillars 42 can smoothly move below the second support pillars 34. Moreover, the third support pillar 42 can be formed so as to have a height shorter than the height of the space within the crush margin of the O-ring (sealing means 54).

Still further, although it is not illustrated in the figure, as another example second securing tool, a slide plate that is formed on the movable plate 83 having the pressurization unit 5 secured thereto and is slidable linearly along a guide, and third support pillars that are secured onto the slide plate may be used. In this case, the slide plate can slide along the guide upon lifting up of the movable plate 83 by the air bearing.

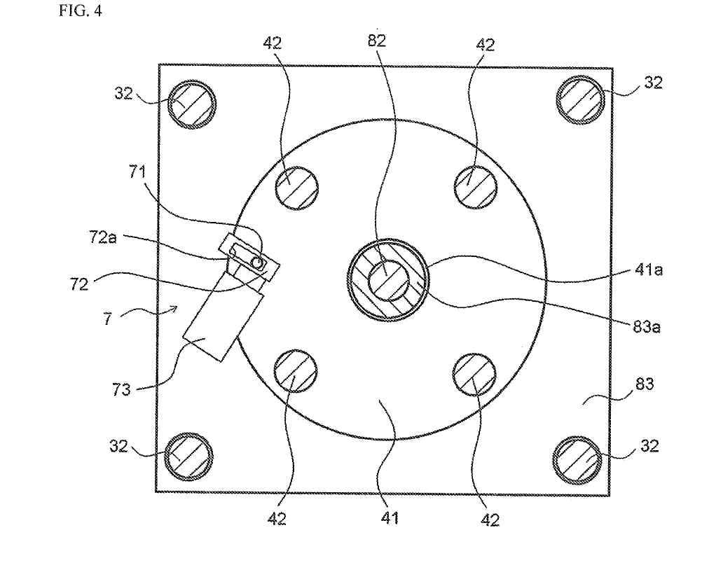

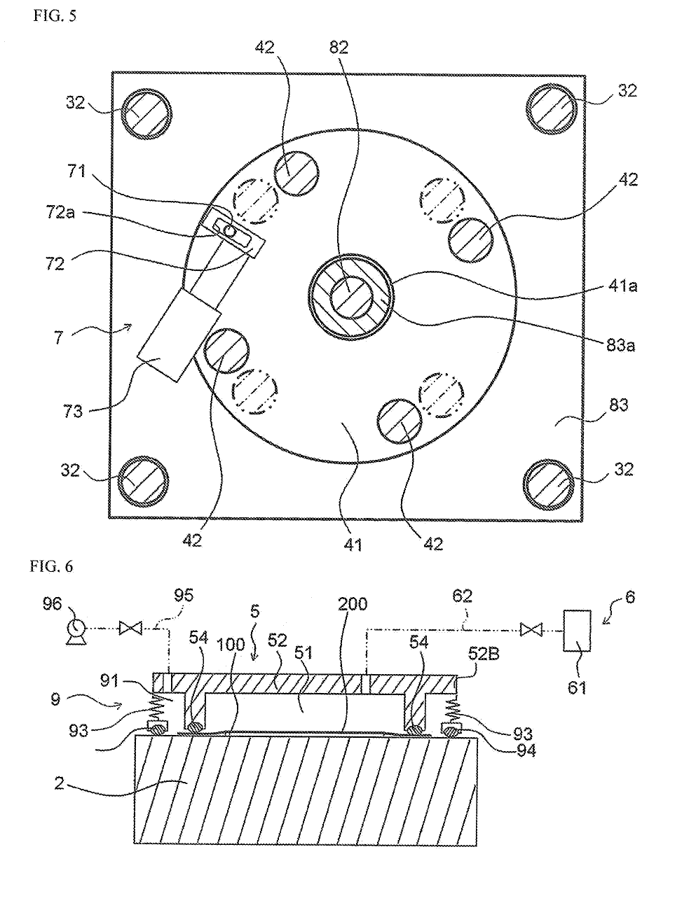

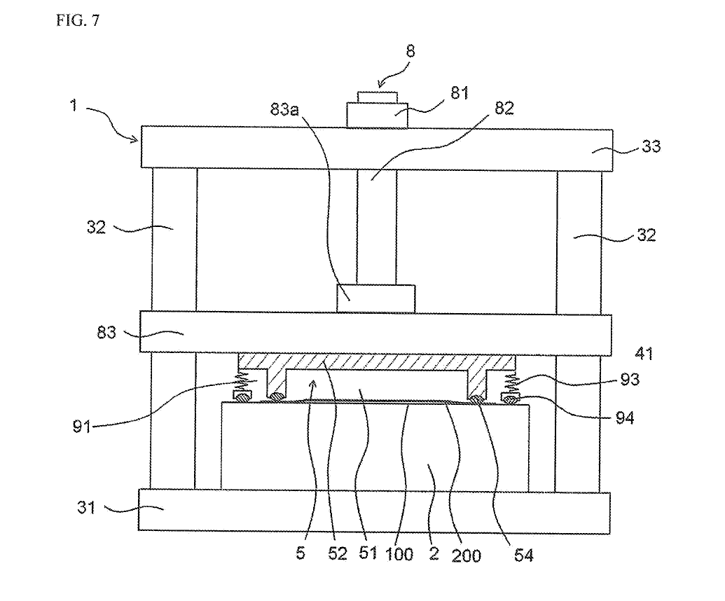

Moreover, securing tool moving means 7 may be provided which relatively moves the first securing tool and the second securing tool. For example, as illustrated in FIG. 4 or 5, the securing tool moving means may include a rotation pin 71 which is secured onto the rotation plate 41, and an actuator 73 which is secured onto the movable plate 83 and has, at the tip thereof, an engagement block 72 with an elongated hole 72a engageable with the rotation pin 71. Accordingly, when the engagement block 72 linearly moves by the actuator 73, the rotation pin 71 slides inside the elongated hole 72a to rotate the rotation plate 41.

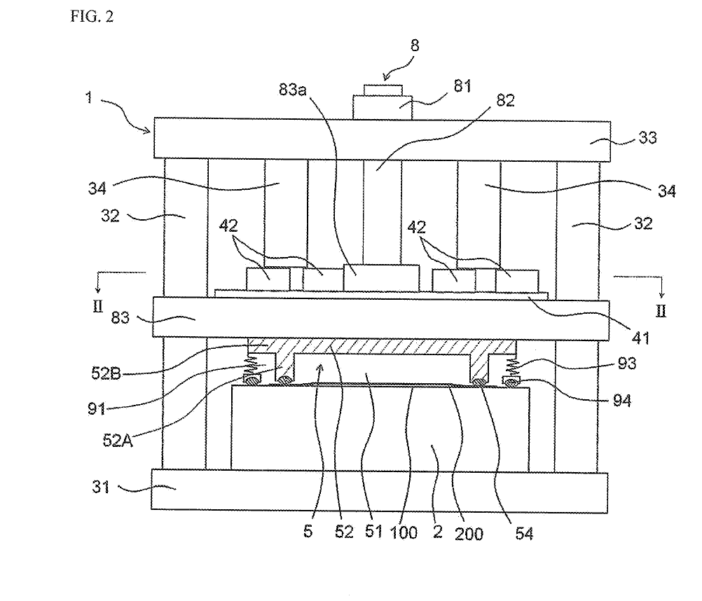

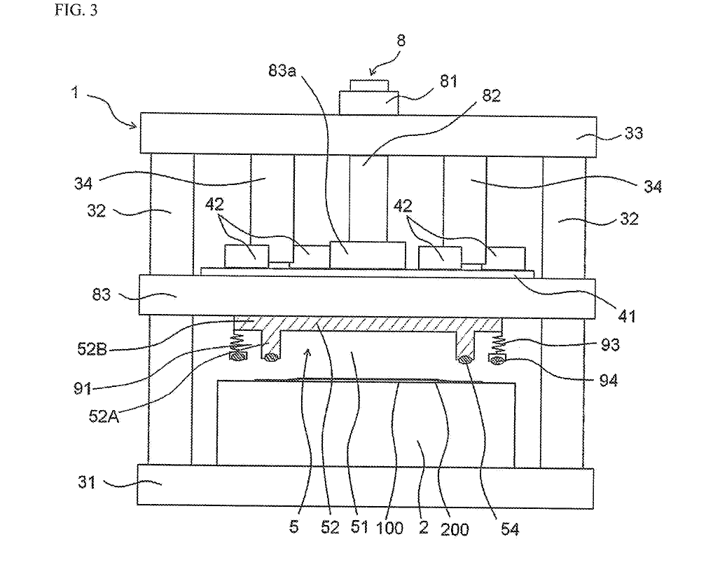

When the imprinting device employs the structure as explained above, the pressurization unit 5 and the stage 2 can be secured by causing the lower surfaces of the second support pillars 34 to contact the corresponding upper surfaces of the third support pillars 42 (see FIG. 1). Accordingly, it is possible to prevent or suppress an application of force generated by the pressurization unit 5 to the opening/closing means 8. Therefore, even if the transfer area increases, a compact opening/closing means 8 is applicable, and the costs of the imprinting device can be reduced. In addition, when the lower surfaces of the second support pillars 34 are separated from the corresponding upper surfaces of the third support pillars 42, the securing of the pressurization unit 5 and the stage 2 can be canceled (see FIG. 2), and the pressurization chamber 51 can be released when the pressurization unit 5 is lifted by what corresponds to the height of the third support pillar 42 using the opening/closing means 8 in this condition (see FIG. 3).

Still further, the imprinting device of the present invention may include a depressurization unit 9 with a depressurization chamber that reduces the pressure of the atmosphere around the die 100 and the molding target 200, in particular, the atmosphere between the die 100 and the molding target 200. Accordingly, the gas present between the die 100, the molding target 200, and the stage 2 can be eliminated, and thus the die 100 and the molding target 200 can be uniformly pressed against each other.

For example, as illustrated in FIG. 6, the depressurization unit 9 may include a depressurization chamber 91 that retains thereinside either one of or both of the die 100 and the molding target 200, a depressurization chamber gas inlet/outlet passage 95 that is connected to the depressurization chamber 91, and a depressurization pump 96 that discharges the gas in the depressurization chamber 91 through the depressurization chamber gas inlet/output passage 95.

The depressurization chamber 91 is formed with the pressurization chamber casing 52, a flange portion 52B that horizontally extends from the upper portion of the pressurization chamber casing 52, a bellows 93 that extends downwardly from the flange portion 52B so as to cove the pressurization chamber casing 52, a seal member 94 that seals a space between the bellows 93 and the stage 2, and the stage 2. Accordingly, the pressurization chamber 51 also serves as apart of the depressurization chamber. Note that the seal member 94 is disposed in a recessed groove (unillustrated) that is formed in the bellows 93 at the stage-2 side. In addition, it is appropriate if the depressurization pump 96 is configured to depressurize the depressurization chamber 91 up to the range where no transfer failure occurs when the molding target 200 is depressed against the die 100. Note that it is needless to mention that the bellows 93 and the seal member 94 have strength withstanding external force when depressurized.

Still further, the pressurization chamber gas inlet/outlet passage 62 and the depressurization chamber gas inlet/outlet passage 95 may be a common passage. In this case, a gas inside the depressurization chamber 91 and the pressurization chamber 51 are discharged to eliminate the gas in the depressurization chamber 91 with the pressurization chamber 51 being released, the pressurization chamber 51 is next closed, and a gas is supplied to the pressurization chamber 51 so as to depress the molding target 200 against the die 100.

Yet further, the imprinting device of the present invention may include other mechanisms like those of general imprinting devices. For example, the imprinting device may further include heating means or cooling means that heats or cools the die 100 and the molding target 200, light emitting means that emits light to the molding target 200, etc.

### REFERENCE SIGNS LIST

1 Securing tool

2 Stage

5 Pressurization unit

6 Pressurization means

7 Securing tool movement means

8 Opening/closing means

9 Depressurization unit

51 Pressurization chamber

52 Pressurization chamber casing

54 Sealing means

100 Die

200 Molding target

1. An imprinting device that transfers a molding pattern of a die to a molding target, the imprinting device comprising:
a pressurization unit that includes a pressurization chamber to pressurize the die and the molding target by a fluid;
a stage that supports the die and the molding target pressurized by the pressurization unit;
pressurization means for adjusting the pressure of the fluid inside the pressurization chamber;
opening/closing means for relatively moving the pressurization unit and the stage; and
a securing tool that secures the pressurization unit and the stage so as to prevent or suppress an application of force generated by the pressurization unit to the opening/closing means.

2. The imprinting device according to claim 1, wherein the securing tool comprises a first securing tool and a second securing tool that are movable relative to each other.

3. The imprinting device according to claim 2, wherein:
the first securing tool is disposed with a space that allows the pressurization unit and the stage to move relative to each other; and
the second securing tool is formed so as to be movable to the space at a position where the pressurization unit pressurizes the die and the molding target.

4. The imprinting device according to claim 2, further comprising securing tool moving means for relatively moving the first securing tool and the second securing tool.

5. The imprinting device according to claim 4, wherein the securing tool moving means moves upon relative rotation of the first securing tool and the second securing tool.

6. The imprinting device according to claim 1, wherein the securing tool receives force generated by the pressurization unit in a distributed manner.

7. The imprinting device according to claim 1, wherein:
the pressurization unit comprises a pressurization chamber casing that forms the pressurization chamber together with the die or the molding target, and sealing means for sealing a space with the die or the molding target: and
the opening/closing means opens and closes the space between the pressurization chamber casing and the die or the molding target.

8. The imprinting device according to claim 1, wherein the pressurization unit comprises a flexible film that is disposed on a surface contacting the die or the molding target, and a pressurization chamber casing that forms the pressurization chamber together with the film.
